(19) United States
(12) Patent Application Publication
(10) Pub. No.: US 2012/0057790 A1
(43) Pub. Date: Mar. 8, 2012

(54) INFORMATION PROCESSING DEVICE, INFORMATION PROCESSING METHOD, AND PROGRAM

(75) Inventors: Shigeru ARISAWA, Tokyo (JP); Atsushi Okubo, Tokyo (JP)

(73) Assignee: SONY CORPORATION, Tokyo (JP)

(21) Appl. No.: 13/206,150

(22) Filed: Aug. 9, 2011

(30) Foreign Application Priority Data
Sep. 8, 2010 (JP) 2010-200734

(51) Int. Cl. G06K 9/46

(52) U.S. Cl. 382/190

(57) ABSTRACT

An information processing device includes: a registration image generating section configured to generate a plurality of registration images assuming a plurality of different lighting conditions at a time of imaging from a registration original image in which a subject to be registered is imaged on a basis of an imaging characteristic of an imaging section; a feature quantity extracting section configured to extract respective feature quantities of an identifying object image in which a subject as an identifying object is imaged and the plurality of registration images; and an identifying section configured to identify the subject of the identifying object image on a basis of degrees of similarity between the feature quantity of the identifying object image and the feature quantities of the plurality of registration images.

### BACKGROUND

The present disclosure relates to an information processing device, an information processing method, and a program, and particularly to an information processing device, an information processing method, and a program suitable for use in identifying an imaged subject, for example.

In related art, there is a face identifying technique that images the face of a person as an identifying object and which identifies the person on the basis of an image obtained as a result of the imaging of the face of the person.

FIG. 1 is a flowchart of assistance in explaining a series of operations (hereinafter referred to as a face identifying process) of the face identifying technique that has existed in the past.

The face identifying process includes a registering phase in which the face of a person (registration person) that can be an identifying object is registered in advance and a determining phase in which the face of a person as an identifying object is identified. The process of steps S1 to S3 to be described below is the registering phase. The process of steps S4 to S7 is the determining phase.

In step S1 of the registering phase, a plurality of registration images of the face of each registration person are picked up under various imaging conditions. The various imaging conditions in this case refer to imaging conditions obtained by varying the position and illuminance of lighting. The various imaging conditions include not only an imaging condition where the face of a person is imaged at an appropriate luminance, that is, an imaging condition indicating an optimum position and an optimum luminance of lighting in which the face of a person is imaged but also for example an inappropriate imaging condition where the luminance of the face of a person is insufficient due to backlight or where the luminance of the face of a person is conversely saturated.

In step S2, the feature quantities of the plurality of registration images are extracted. In step S3, the feature quantities extracted from the plurality of registration images are stored in a database so as to be associated with respective registration persons.

In step S4 of the determining phase, the face of a person as an identifying object is imaged, and an identifying object image is generated. In step S5, the feature quantity of the identifying object image is extracted.

In step S6, degrees of similarity between the feature quantity of the identifying object image and the feature quantities of the registration images registered in the database are calculated. In step S7, the person of the identifying object image is identified as one of the registration persons on the basis of the calculated degrees of similarity (the person of the identifying object image may be identified as none of the registration persons).

As described above, the feature quantities of registration images picked up under inappropriate imaging conditions are also registered in the registering phase. Thereby, even when the face of a person as an identifying object is imaged under an inappropriate imaging condition in the determining phase, the face can be identified.

However, the above-described face identifying process requires a plurality of times of imaging to be performed under various imaging conditions for a same registration person in the registering phase. This process is troublesome.

Accordingly, a method has also been proposed which images a registration person only once and which provides a plurality of registration images by making various corrections to an image obtained as a result of the imaging of the registration person (see Japanese Patent Laid-Open No. 2008-251039, for example).

### SUMMARY

As described above, obtaining a plurality of registration images by correcting an image obtained by imaging has been proposed in the past. Specifically, however, the correction simply brightens or darkens the image as a whole.

In addition, to increase accuracy of determination in the determining phase, registration images should be generated by a correction that takes into consideration the characteristic of an imaging section (camera) for picking up an identifying object image and the like. However, such a method has not been proposed in a present situation.

The present disclosure has been made in view of such a situation. It is desirable to improve accuracy of determination in the determining phase by generating registration images by a correction based on the characteristic of an imaging section (camera) for picking up an identifying object image.

An information processing device according to one embodiment of the present disclosure includes: a registration image generating section configured to generate a plurality of registration images assuming a plurality of different lighting conditions at a time of imaging from a registration original image in which a subject to be registered is imaged on a basis of an imaging characteristic of an imaging section; a feature quantity extracting section configured to extract respective feature quantities of an identifying object image in which a subject as an identifying object is imaged and the plurality of registration images; and an identifying section configured to identify the subject of the identifying object image on a basis of degrees of similarity between the feature quantity of the identifying object image and the feature quantities of the plurality of registration images.

The registration image generating section can generate a registration image by saturation processing assuming overexposure at the time of imaging from the registration original image in which the subject to be registered is imaged on the basis of the imaging characteristic.

The imaging characteristic can include at least one of a parameter of γ-correction and a threshold value in knee correction in the imaging section.

The registration image generating section can further generate a registration image by discrete reduction processing assuming underexposure at the time of imaging from the registration original image in which the subject to be registered is imaged.

The information processing device according to one embodiment of the present disclosure can further include an obtaining section configured to obtain the imaging characteristic from the imaging section imaging a subject as an object of registration or identification.

The information processing device according to one embodiment of the present disclosure can further include a retaining section configured to retain the imaging characteristic of the imaging section imaging a subject as an object of registration or identification in advance.

An information processing method according to one embodiment of the present disclosure includes: by an information processing device, generating a plurality of registration images assuming a plurality of different lighting conditions at a time of imaging from a registration original image in which a subject to be registered is imaged on a basis of an imaging characteristic of an imaging section; extracting respective feature quantities of the plurality of registration images; extracting a feature quantity of an identifying object image in which a subject as an identifying object is imaged; and identifying the subject of the identifying object image on a basis of degrees of similarity between the feature quantity of the identifying object image and the feature quantities of the plurality of registration images.

A program according to one embodiment of the present disclosure makes a computer function as: a registration image generating section configured to generate a plurality of registration images assuming a plurality of different lighting conditions at a time of imaging from a registration original image in which a subject to be registered is imaged on a basis of an imaging characteristic of an imaging section; a feature quantity extracting section configured to extract respective feature quantities of an identifying object image in which a subject as an identifying object is imaged and the plurality of registration images; and an identifying section configured to identify the subject of the identifying object image on a basis of degrees of similarity between the feature quantity of the identifying object image and the feature quantities of the plurality of registration images.

In one embodiment of the present disclosure, a plurality of registration images assuming a plurality of different lighting conditions at a time of imaging are generated from a registration original image in which a subject to be registered is imaged on a basis of an imaging characteristic of an imaging section. In addition, respective feature quantities of an identifying object image in which a subject as an identifying object is imaged and the plurality of registration images are extracted, and the subject of the identifying object image is identified on a basis of degrees of similarity between the feature quantity of the identifying object image and the feature quantities of the plurality of registration images.

According to one embodiment of the present disclosure, it is possible to improve accuracy of determination in the determining phase.

### BRIEF DESCRIPTION OF THE DRAWINGS

FIG. 1 is a flowchart of assistance in explaining a face identifying process in related art;

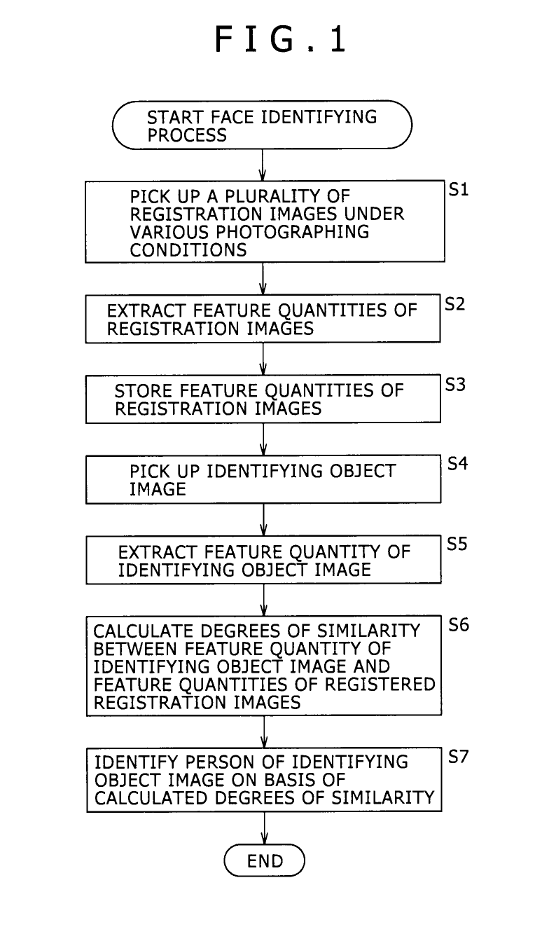

FIG. 2 is a block diagram showing an example of configuration of an image identifying device to which the present technology is applied;

FIG. 3 is a block diagram showing an example of detailed configuration of a registration image generating section in FIG. 2;

FIG. 4 is a diagram of assistance in explaining a state of imaging being performed with overexposure and a state of imaging being performed with underexposure;

FIG. 5 is a diagram of assistance in explaining saturation processing based on knee correction;

FIG. 6 is a diagram of assistance in explaining saturation processing based on γ-correction;

FIG. 7 is a diagram of assistance in explaining detail processing;

FIG. 8 is a flowchart of assistance in explaining a face identifying process to which the present technology is applied; and

FIG. 9 is a block diagram showing an example of configuration of a computer.

### DETAILED DESCRIPTION OF THE PREFERRED EMBODIMENT

The best mode for carrying out the technology (which best mode will hereinafter be referred to as an embodiment) will hereinafter be described in detail with reference to the drawings.

### [Example of Configuration of Image Identifying Device]

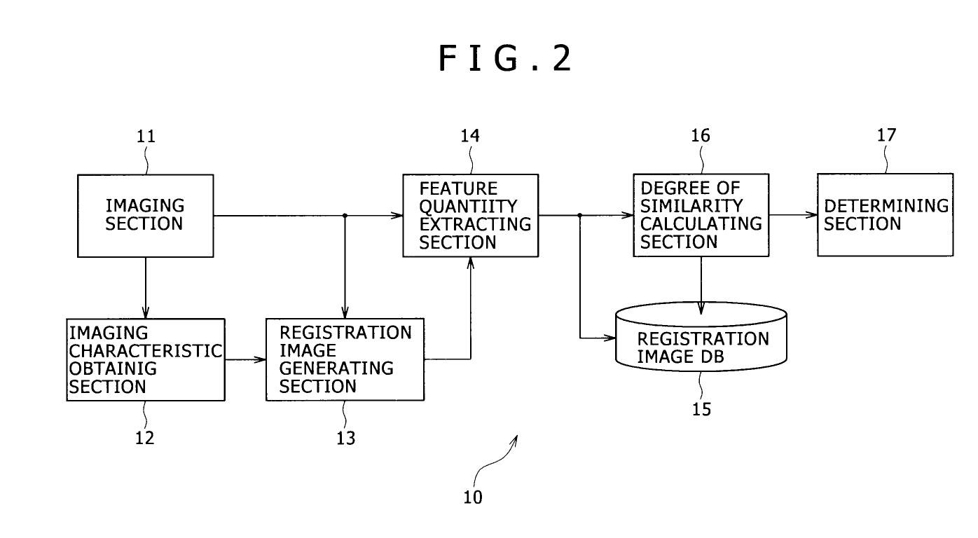

FIG. 2 shows an example of configuration of an image identifying device according to an embodiment of the present disclosure.

The image identifying device 10 in a registering phase images a subject to be registered (for example the face of a person), generates a plurality of registration images by subjecting an image obtained as a result of the imaging of the subject to predetermined image processing, extracts the feature quantities of the plurality of registration images, and stores the feature quantities of the plurality of registration images in a database. Alternatively, the image identifying device 10 in a determining phase determines whether a subject of an identifying object image is one of subjects registered in advance.

The image identifying device 10 includes an imaging section 11, an imaging characteristic obtaining section 12, a registration image generating section 13, a feature quantity extracting section 14, a registration image DB (database) 15, a degree of similarity calculating section 16, and a determining section 17.

The imaging section 11 is formed by a digital camera, for example. The imaging section 11 in a registering phase picks up a monochrome image of a subject to be registered, and outputs a luminance image obtained as a result of the imaging of the subject (which luminance image will hereinafter be referred to as a registration original image) to the registration image generating section 13. In addition, the imaging section 11 in a determining phase picks up a monochrome image of a subject to be set as an identifying object, and outputs a luminance image obtained as a result of the imaging of the subject (which luminance image will hereinafter be referred to as an identifying object image) to the feature quantity extracting section 14. Incidentally, the imaging section 11 may pick up a color image of a subject, and attention may be directed to only a luminance component of pixels of the color image.

The imaging characteristic obtaining section 12 analyzes the imaging characteristic of the imaging section 11, specifically a picked-up image, thereby obtains a parameter in γ-correction, a knee correction threshold value in knee correction, or the like, and notifies the parameter, the knee correction threshold value, or the like to the registration image generating section 13.

Incidentally, the imaging characteristic of the imaging section 11 which imaging characteristic is obtained or estimated in advance may be retained in a memory (not shown) or the like provided within the registration image generating section 13. In this case, the retained imaging characteristic may be used when the imaging characteristic obtaining section 12 cannot obtain the imaging characteristic from the imaging section 11, or the imaging characteristic obtaining section 12 may be omitted. Further, though depending on the format of an image output by the imaging section 11, the imaging characteristic may be read out from the property information of the image.

The registration image generating section 13 performs predetermined image processing on the registration original image input from the imaging section 11 on the basis of the notified imaging characteristic of the imaging section 11, and outputs a plurality of registration images obtained as a result of the image processing to the feature quantity extracting section 14. In addition, the registration image generating section 13 outputs the input registration original image as it is as a registration image to the feature quantity extracting section 14.

The feature quantity extracting section 14 in a registering phase extracts the feature quantities of the plurality of registration images input from the registration image generating section 13, and outputs the feature quantities of the plurality of registration images to the registration image DB 15. In addition, the feature quantity extracting section 14 in a determining phase extracts the feature quantity of an identifying object image input from the imaging section 11, and outputs the feature quantity of the identifying object image to the degree of similarity calculating section 16. Incidentally, a feature quantity extracting method is arbitrary.

The registration image DB 15 registers therein the feature quantities extracted from the plurality of registration images corresponding to the subject to be registered in association with identifying information of the subject to be registered.

The degree of similarity calculating section 16 in a determining phase calculates a degree of similarity between the feature quantity of an identifying object image and the feature quantity of each registration image registered in the registration image DB 15, and outputs the degree of similarity to the determining section 17. In this case, when the feature quantities are expressed by multidimensional vectors, for example, the degree of similarity can be expressed by a distance between the vectors.

The determining section 17 determines whether the subject of the identifying object image is identical with one of the subjects registered in advance on the basis of the degree of similarity calculated by the degree of similarity calculating section 16.

### [Example of Detailed Configuration of Registration Image Generating Section 13]

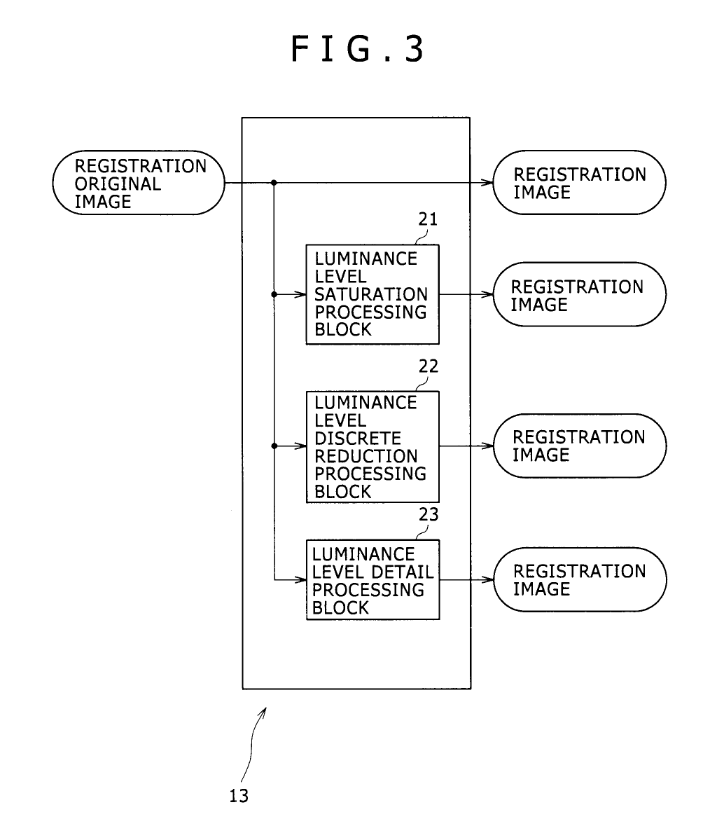

FIG. 3 shows an example of detailed configuration of the registration image generating section 13.

The registration image generating section 13 includes a luminance level saturation processing block 21, a luminance level discrete reduction processing block 22, and a luminance level detail processing block 23.

The luminance level saturation processing block 21 generates a registration image by subjecting the registration original image to image processing for reproducing a state of imaging being performed with overexposure. Conversely, the luminance level discrete reduction processing block 22 generates a registration image by subjecting the registration original image to image processing for reproducing a state of imaging being performed with underexposure.

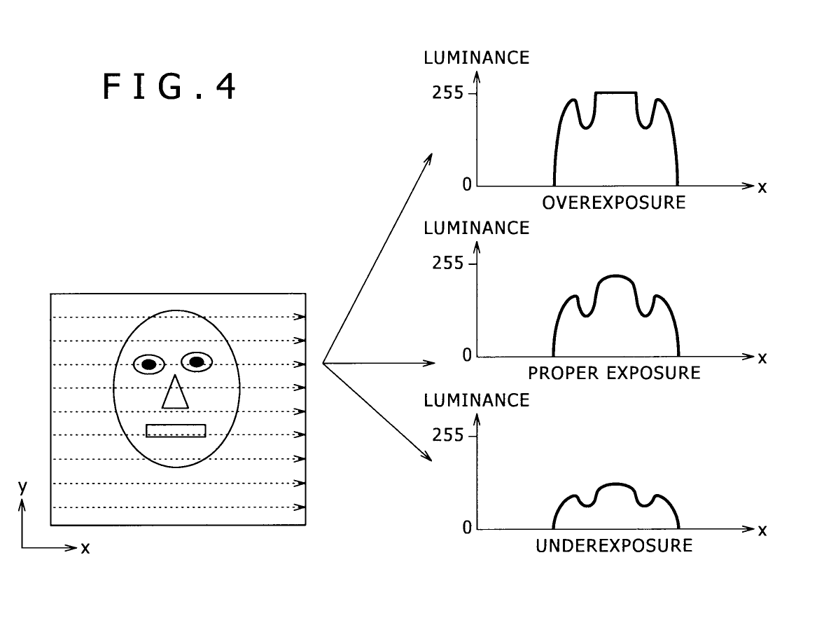

FIG. 4 shows a state of imaging being performed with overexposure and a state of imaging being performed with underexposure. Description in the following will be made by taking as an example a case where the face of a person is imaged and attention is directed to an x-direction line around the eyes, as shown in FIG. 4.

In a case of proper exposure at a time of imaging, the luminance is distributed in an allowed range (for example 0 to 255 in a case of 8 bits). However, in a case of overexposure at the time of imaging, the luminance as a whole is a high value, and some pixels are saturated at a maximum value (for example 255 in the case of 8 bits). Conversely, in a case of underexposure at the time of imaging, the luminance as a whole is a low value, and differences in luminance between pixels are reduced, that is, quantization errors occur.

Accordingly, the luminance level saturation processing block 21 generates a registration image by increasing the luminance of the registration original image on the basis of the imaging characteristic of the imaging section 11 and replacing the values of pixels exceeding the maximum value (for example 255 in the case of 8 bits) allowed to luminance with the maximum value. Incidentally, a plurality of registration images that have different areas of saturated pixels and in which overexposure is reproduced may be generated by changing a degree to which the luminance of the registration original image is increased.

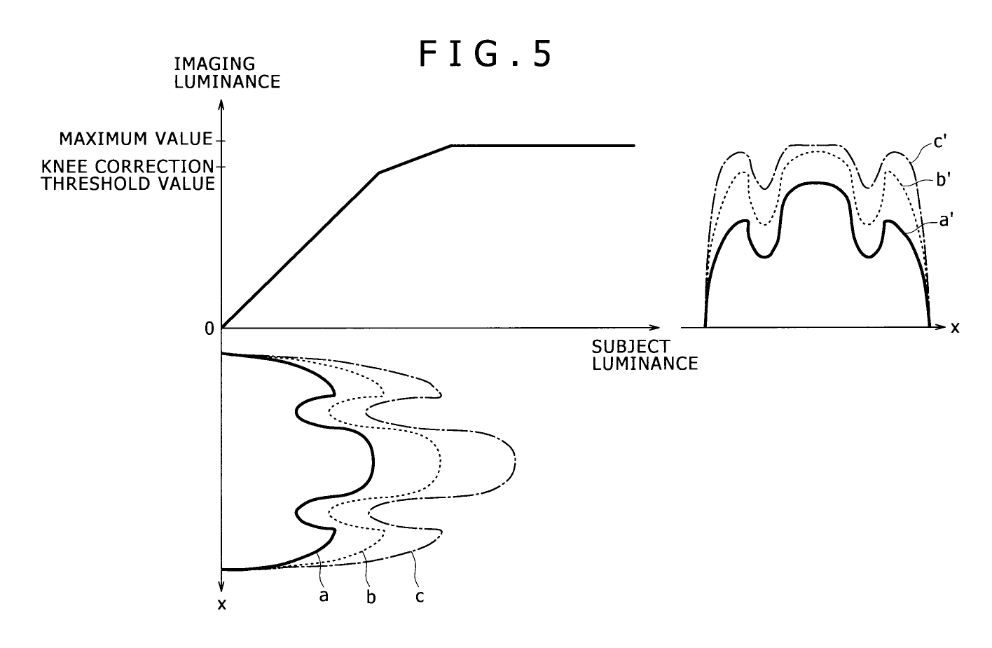

Specifically, as shown in FIG. 5, when the imaging section 11 makes knee correction that compresses a high-luminance region exceeding a knee correction threshold value, the luminance of the registration original image which luminance is represented by a curve a is increased to luminance represented by a curve b, and the value of luminance exceeding the knee correction threshold value is compressed, whereby a registration image represented by a curve b′ is generated. In addition, the luminance of the registration original image which luminance is represented by the curve a is increased to luminance represented by a curve c, the value of luminance exceeding the knee correction threshold value is compressed, and luminance exceeding the maximum value is replaced with the maximum value, whereby a registration image represented by a curve c′ is generated.

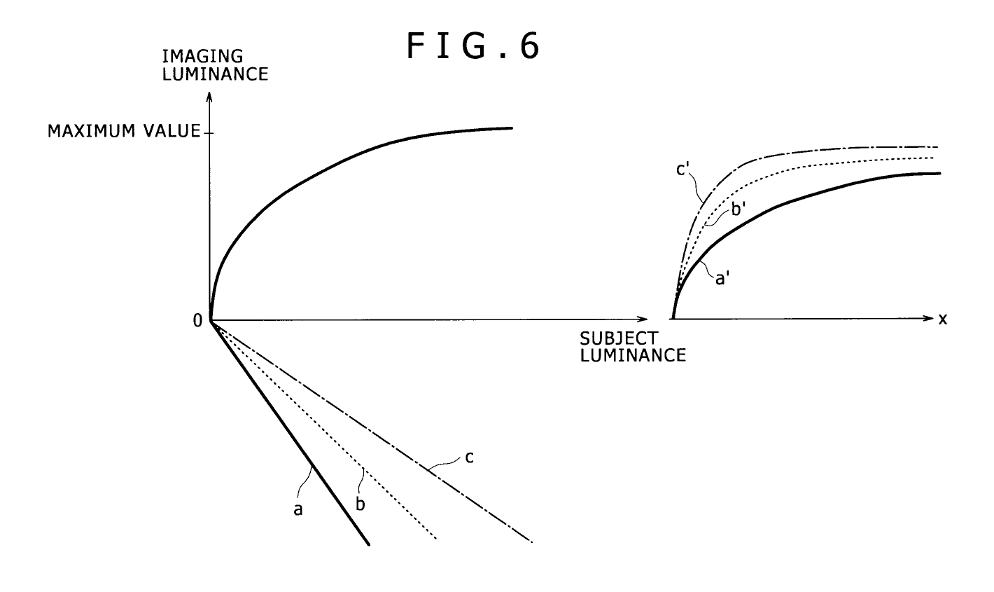

In addition, as shown in FIG. 6, when the imaging section 11 makes γ-correction, the luminance of the registration original image is increased, and thereafter γ-correction is made, whereby a registration image is generated. In addition, the luminance of the registration original image which luminance is represented by a curve a is increased to luminance represented by a curve c, the value of luminance exceeding the knee correction threshold value is compressed, and luminance exceeding the maximum value is replaced with the maximum value, whereby a registration image represented by a curve c′ is generated.

Returning to FIG. 3, the luminance level discrete reduction processing block 22 decreases luminance by discretely reducing the higher-order bits of the luminance of the registration original image, and thereby intentionally generates a registration image in which quantization errors occur. Incidentally, a plurality of registration images in which underexposure is reproduced may be generated, such as a registration image obtained by discretely reducing the luminance of the registration original image by one bit from the side of the higher-order bits, a registration image obtained by discretely reducing the luminance of the registration original image by two bits from the side of the higher-order bits, and a registration image obtained by discretely reducing the luminance of the registration original image by three bits from the side of the higher-order bits.

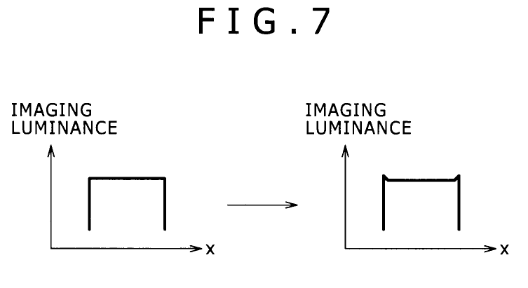

The luminance level detail processing block 23 generates a registration image by subjecting the registration original image to processing that emphasizes luminance edges as shown in FIG. 7, for example.

The respective registration images generated in the luminance level saturation processing block 21, the luminance level discrete reduction processing block 22, and the luminance level detail processing block 23 are output to the feature quantity extracting section 14.

Incidentally, the registration image generating section 13 may further generate a registration image by performing processing for reproducing a state in which imaging is performed without focus being achieved.

### [Description of Operation]

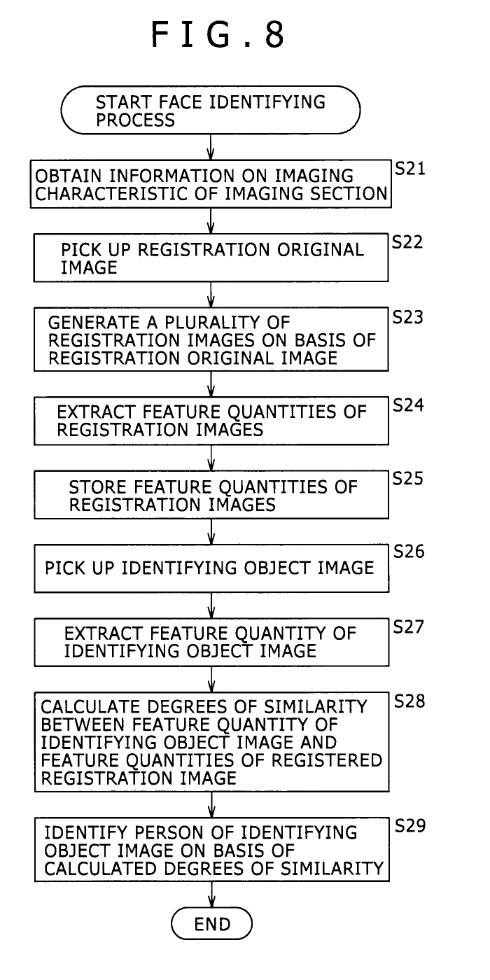

The operation of the image identifying device 10 will next be described with reference to FIG. 8. FIG. 8 is a flowchart of assistance in explaining a face identifying process by the image identifying device 10.

The face identifying process includes a registering phase in which the face of a person (registration person) that can be an identifying object is registered in advance and a determining phase in which the face of a person as an identifying object is identified. The process of steps S21 to S25 to be described below is the registering phase. The process of steps S26 to S29 is the determining phase.

In step S21 of the registering phase, the imaging characteristic obtaining section 12 obtains the imaging characteristic of the imaging section 11, and notifies the imaging characteristic of the imaging section 11 to the registration image generating section 13.

In step S22, the imaging section 11 images the face of each registration person, and outputs a resulting registration original image to the registration image generating section 13.

In step S23, the registration image generating section 13 outputs a plurality of registration images generated from the registration original image input from the imaging section 11 on the basis of the notified imaging characteristic of the imaging section 11 to the feature quantity extracting section 14. In addition, the registration image generating section 13 outputs the registration original image as it is as a registration image to the feature quantity extracting section 14.

In step S24, the feature quantity extracting section 14 extracts respective feature quantities from the plurality of registration images, and outputs the feature quantities to the registration image DB 15. In step S25, the registration image DB 15 registers therein the feature quantities extracted from the plurality of registration images corresponding to the subject to be registered in association with identifying information of the subject to be registered.

In step S26 of the determining phase, the imaging section 11 images the face of a person as an identifying object, and outputs a resulting identifying object image to the feature quantity extracting section 14. In step S27, the feature quantity extracting section 14 extracts the feature quantity of the identifying object image, and outputs the feature quantity of the identifying object image to the degree of similarity calculating section 16.

In step S28, referring to the registration image DB 15, the degree of similarity calculating section 16 calculates a degree of similarity between the feature quantity of the identifying object image and the feature quantity of each registration image registered in the registration image DB 15, and outputs the degree of similarity to the determining section 17. In step S29, the determining section 17 identifies the person of the identifying object image as one of registration persons on the basis of the calculated degree of similarity. Then the face identifying process is ended.

The above-described face identifying process generates a plurality of registration images from a registration original image with consideration given to the imaging characteristic, and is thus able to determine the person of an identifying object image without decreasing accuracy of determination even if the identifying object image is picked up with overexposure or conversely picked up with underexposure.

Incidentally, while the present embodiment generates a plurality of registration images from a registration original image and calculates and registers the feature quantities of the plurality of registration images in the registering phase, only the feature quantity of the registration original image may be calculated and registered in the registering phase, and the plurality of registration images may be generated from the registration original image and the feature quantities of the plurality of registration images may be calculated in the identifying phase.

In addition, while the face of a person is set as an identifying object in the present embodiment, the identifying object is not limited to this, but is arbitrary.

The series of processes described above can be carried out not only by hardware but also by software. When the series of processes is to be carried out by software, a program constituting the software is installed from a program recording medium onto a computer incorporated in dedicated hardware or for example a general-purpose personal computer that can perform various functions by installing various programs thereon.

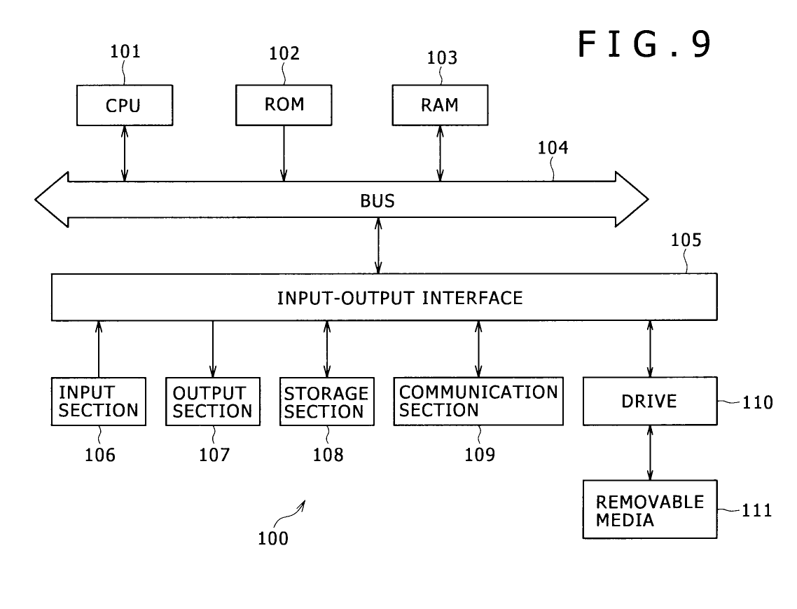

FIG. 9 is a block diagram showing an example of hardware configuration of a computer performing the series of processes described above by a program.

In the computer 100, a CPU (Central Processing Unit) 101, a ROM (Read Only Memory) 102, and a RAM (Random Access Memory) 103 are interconnected by a bus 104.

The bus 104 is further connected with an input-output interface 105. The input-output interface 105 is connected with an input section 106 formed by a keyboard, a mouse, a microphone and the like, an output section 107 formed by a display, a speaker and the like, a storage section 108 formed by a hard disk, a nonvolatile memory and the like, a communicating section 109 formed by a network interface and the like, and a drive 110 for driving removable media 111 such as a magnetic disk, an optical disk, a magneto-optical disk, a semiconductor memory and the like.

In the computer 100 configured as described above, the CPU 101 for example loads a program stored in the storage section 108 into the RAM 103 via the input-output interface 105 and the bus 104, and then executes the program. Thereby the series of processes described above is performed.

It is to be noted that the program executed by the computer may be a program in which processing is performed in time series in the order described in the present specification or may be a program in which processing is performed in parallel or in necessary timing such as at a time of a call being made, for example.

In addition, the program may be processed by one computer, or may be subjected to distributed processing by a plurality of computers. Further, the program may be transferred to a remote computer and executed by the remote computer.

It is to be noted that embodiments of the present disclosure are not limited to the foregoing embodiments, and that various changes can be made without departing from the spirit of the present disclosure.

The present disclosure contains subject matter related to that disclosed in Japanese Priority Patent Application JP 2010-200734 filed in the Japan Patent Office on Sep. 8, 2010, the entire content of which is hereby incorporated by reference.

What is claimed is:

1. An information processing device comprising:
a registration image generating section configured to generate a plurality of registration images assuming a plurality of different lighting conditions at a time of imaging from a registration original image in which a subject to be registered is imaged on a basis of an imaging characteristic of an imaging section;
a feature quantity extracting section configured to extract respective feature quantities of an identifying object image in which a subject as an identifying object is imaged and said plurality of registration images; and
an identifying section configured to identify the subject of said identifying object image on a basis of degrees of similarity between the feature quantity of said identifying object image and the feature quantities of said plurality of registration images.

2. The information processing device according to claim 1,
wherein said registration image generating section generates a said registration image by saturation processing assuming overexposure at the time of imaging from the registration original image in which the subject to be registered is imaged on the basis of said imaging characteristic.

3. The information processing device according to claim 1,
wherein said imaging characteristic includes at least one of a parameter of γ-correction and a threshold value in knee correction in said imaging section.

4. The information processing device according to claim 1,
wherein said registration image generating section further generates a said registration image by discrete reduction processing assuming underexposure at the time of imaging from the registration original image in which the subject to be registered is imaged.

5. The information processing device according to claim 1, further comprising
an obtaining section configured to obtain said imaging characteristic from said imaging section imaging a subject as an object of registration or identification.

6. The information processing device according to claim 1, further comprising
a retaining section configured to retain said imaging characteristic of said imaging section imaging a subject as an object of registration or identification in advance.

7. An information processing method of an information processing device, said information processing method comprising:
by the information processing device,
generating a plurality of registration images assuming a plurality of different lighting conditions at a time of imaging from a registration original image in which a subject to be registered is imaged on a basis of an imaging characteristic of an imaging section;
extracting respective feature quantities of said plurality of registration images;
extracting a feature quantity of an identifying object image in which a subject as an identifying object is imaged; and
identifying the subject of said identifying object image on a basis of degrees of similarity between the feature quantity of said identifying object image and the feature quantities of said plurality of registration images.

8. A program for making a computer function as:
a registration image generating section configured to generate a plurality of registration images assuming a plurality of different lighting conditions at a time of imaging from a registration original image in which a subject to be registered is imaged on a basis of an imaging characteristic of an imaging section;
a feature quantity extracting section configured to extract respective feature quantities of an identifying object image in which a subject as an identifying object is imaged and said plurality of registration images; and
an identifying section configured to identify the subject of said identifying object image on a basis of degrees of similarity between the feature quantity of said identifying object image and the feature quantities of said plurality of registration images.
